(19) United States
(12) Patent Application Publication
(10) Pub. No.: US 2012/0203895 A1
(43) Pub. Date: Aug. 9, 2012

(54) Trending Engine for Virtual Computing Environment

(75) Inventors: Joe Jaudon, Sedalia, CO (US); David Lowrey, Denver, CO (US); Adam Williams, Aurora, CO (US)

(73) Assignee: AventuraHQ, Inc., Denver, CO (US)

(21) Appl. No.: 13/368,824

(22) Filed: Feb. 8, 2012

Related U.S. Application Data
(60) Provisional application No. 61/440,719, filed on Feb. 8, 2011.

(51) Int. Cl. G06F 15/173

(52) U.S. Cl. 709/224

(57) ABSTRACT

Methods, systems, devices, and computer program products are described to monitor trends in workflow in a virtual computing environment, and adapt a session according to these monitored trends. Sessions may be monitored based on a type of user involved, a type of machine or application accessed, and/or specific locations. The workflow of a user within a session may be monitored as well. Certain correlations between past and future actions are identified. Future events may be anticipated or predicted based on an association between events, types of users, types of machines and applications, and/or specific locations. Using this trending information, workflow can be anticipated and sessions can be adapted proactively.

### CROSS REFERENCES

The present application claims the benefit of priority to U.S. Provisional Patent Application No. 61/440,719, filed Feb. 8, 2011, entitled “TRENDING ENGINE FOR VIRTUAL COMPUTING ENVIRONMENT,” which is incorporated by reference in its entirety for all purposes.

### BACKGROUND

This invention relates to computer network communication, and more particularly, to a trending engine for a virtual desktop architecture.

Various computer systems may use a thin-client or a virtual desktop display in conjunction with a centralized server computer system or mainframe. Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

A virtual desktop display can be served to client devices from a central or distributed server computer system. The server may receive input and output over a network or other communication medium established between the device and the server. In some examples, a thin-client device may run web browsers or remote desktop software, such that significant processing may occur on the server.

In many instances, users may be delayed as they transition to new applications (e.g., when they move to new locations). This wait time can significantly impact productivity and efficiency. Thus, there may be a need in the art to reduce wait periods as users transition in and out of different workflows.

### SUMMARY

Methods, systems, devices, and computer program products are described to address trending in a virtual computing environment. Sessions may be monitored based on a type of user involved, a type of computer or application accessed, and movement to or between specific locations. The workflow of a user (e.g., use or inactivation of an application) within a session may be monitored as well. Certain correlations between past and future actions are identified. Future events may be anticipated or predicted based on an association between events, types of users, types of computers and applications, and/or specific locations. Using this trending information, workflow can be anticipated and sessions can be adapted proactively. Rules may be generated tying triggering event and resultant actions. Triggering events may be detected, and rules may be applied based of the detected triggering events.

In a first set of embodiments, a method for session management in a virtual computing environment includes monitoring workflow for a series of user sessions and detecting a triggering event in the monitored workflow that indicates a change in user interaction state of a user of the virtual computing environment. The method further includes identifying a trending action associated with the triggering event according to a trending rule that is based on a correlation between the triggering event and the trending action in previous user sessions, applying the trending action to a user session, the trending action modifying the user session, and serving the modified user session to a computer of the virtual computing environment associated with the user session.

According to aspects consistent with various embodiments, the method includes identifying a correlation between the triggering event and the trending action for users of a first user type in the monitored workflow and generating the trending rule associating the trending action with the triggering event according to the first user type. Detecting the triggering event may include receiving a user log-in to a client device of the virtual computing environment. Upon receiving the user log-in, the system may determine a location transition of the user based on the client device and information related to a previous log-in of the user to the virtual computing environment and/or determine a user type associated with the user. The method may further include identifying a triggering event associated with the location transition and/or the user type. The method may include initiating the user session in response to the user log-in. In various embodiments, a workflow event may be received that indicates a change in workflow information and detecting the triggering event in the monitored workflow may be based at least in part on the workflow event.

In a second set of embodiments, a computer system for managing sessions in a virtual computing environment includes a monitoring module that monitors workflow for a series of user sessions, a rules detection module that detects a triggering event in the monitored workflow that indicates a change in user interaction state of a user of the virtual computing environment, a rules data store that stores a trending rule that associates a trending action with the triggering event based on a correlation between the triggering event and the trending action in previous user sessions, a rule application module that applies the trending action to a user session, the trending action modifying the user session before the user session is served to a client device of the virtual computing environment.

According to yet other aspects consistent with various embodiments, the computer system includes a monitoring module that monitors workflow for a series of user sessions, a trending engine that identifies the correlation between the triggering event and the trending action for users of a first user type in the monitored workflow, and a rules generator that generates the trending rule associating the trending action with the triggering event according to the first user type. The rules detection module may detect the triggering event according to a location transition that is determined based on a user log-in to a client device of the virtual computing environment and information related to a previous log-in of the user to the virtual computing environment. The rules detection module may receive a user log-in to a client device of the virtual computing environment and identify the triggering event based at least in part on the user type associated with the user based on user log-in information. The computer system may initiate the user session in response to the user log-in. In embodiments, the monitoring module receives a workflow event indicating a change in workflow information and the rules detection module detects the triggering event in the monitored workflow at least in part on the workflow event.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example central server computer system including components configured according to various embodiments of the invention.

FIG. 3 is a block diagram of an example central server computer system including components configured according to various embodiments of the invention.

FIG. 4 is a block diagram of an example central server computer system including components configured according to various embodiments of the invention.

FIG. 5 is a block diagram of an example system including components configured according to various embodiments of the invention.

FIG. 6A is a block diagram of an example virtual computing environment employing a central server computer system including components configured according to various embodiments of the invention.

FIG. 6B is a block diagram of an example virtual computing environment employing a central server computer system including components configured according to various embodiments of the invention.

FIG. 6C is a block diagram of an example virtual computing environment employing a central server computer system including components configured according to various embodiments of the invention.

FIG. 7A is a block diagram of an example virtual computing environment employing a central server computer system including components configured according to various embodiments of the invention.

FIG. 7B is a block diagram of an example virtual computing environment employing a central server computer system including components configured according to various embodiments of the invention.

FIG. 8 is a flowchart diagram of an example method of adapting sessions according to monitored trends in a virtual computing environment, according to various embodiments of the invention.

FIG. 9 is a flowchart diagram of an example method of adapting sessions according to monitored trends in a virtual computing environment, according to various embodiments of the invention.

FIG. 10 is a flowchart diagram of an example method of adapting sessions according to monitored trends in a virtual computing environment, according to various embodiments of the invention.

FIG. 11 is a flowchart diagram of an example method of adapting sessions according to monitored trends in a virtual computing environment, according to various embodiments of the invention.

FIG. 12 is a schematic diagram that illustrates a representative device structure that may be used in various embodiments of the present invention.

### DETAILED DESCRIPTION OF THE INVENTION

Methods, systems, devices, and computer program products are described to monitor trends in workflow in a virtual desktop infrastructure, and adapt a session according to these monitored trends. Sessions in a virtual computing environment may be monitored based on a type of user involved, a type of client device or application accessed, specific locations, time of day, security levels, and/or other parameters. The workflow of a user within a session may be monitored as well. Certain correlations between past and future actions are identified. Future events may be anticipated or predicted based on an association between events, types of users, types of computers and applications, and/or specific locations. Using this trending information, workflow can be anticipated and sessions can be adapted proactively.

This description provides examples only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components as appropriate. For instance, it should be appreciated that in alternative embodiments the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, devices, and software may individually or collectively be components of a larger system, wherein other procedures may take precedence over or otherwise modify their application. Also, a number of steps may be required before, after, or concurrently with the following embodiments.

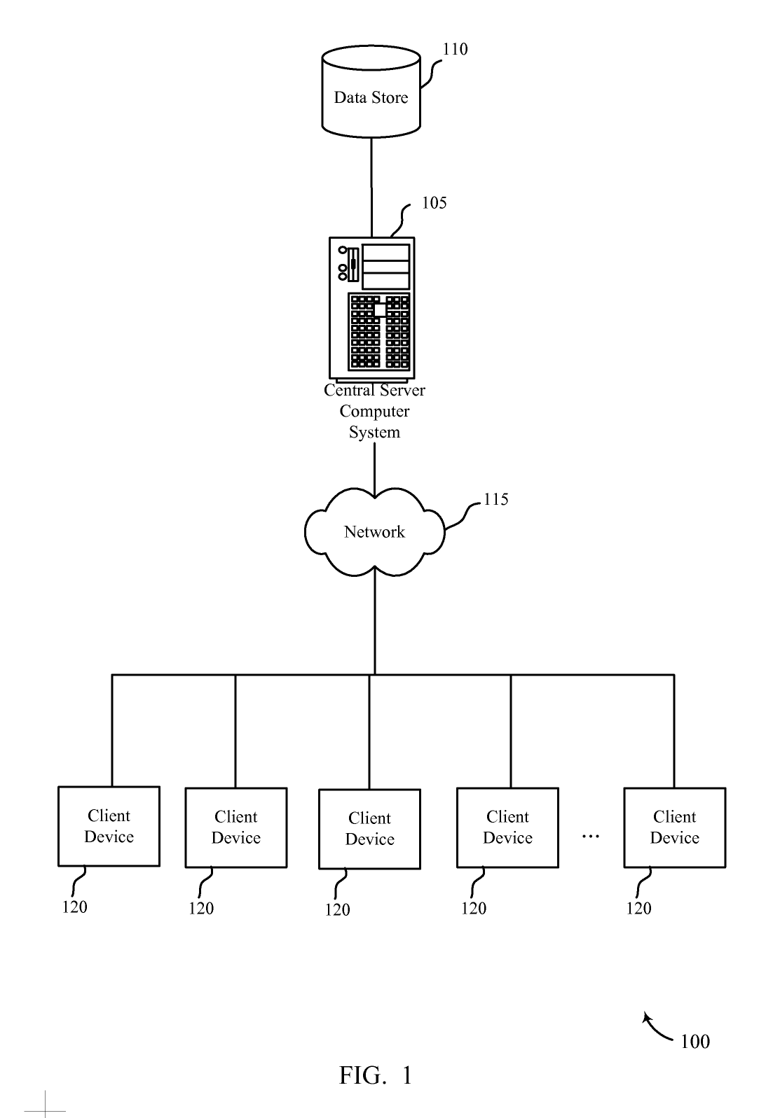

Systems, devices, methods, and software are described for a virtual computing environment. In one set of embodiments, shown in FIG. 1, system 100 includes a central server computer system 105, data store 110, network 115, and client devices 120. Each of these components may be in communication with each other, directly or indirectly. For example, each of these components may be in communication over wired and/or wireless communication links through network 115.

The central server computer system 105 may be configured to run sessions of a virtual computing environment for one or more users, and the session may be allowed to roam with a user as he or she moves between client devices 120. As used herein, the term “session” or “user session” refers to a hosted session of a virtual computing environment that may be accessed from one or more client devices of the virtual computing environment. For example, a session may include a thin client session, a virtual application session, a virtual machine session, a virtual operating system session, and/or the like. In some embodiments, some of the functions of the central server computer system 105 in this process may be distributed to or among computers. The central server computer system 105 may serve a session to specific client devices 120 in the network. As used herein, a virtual computing environment includes any network whereby KVM (keyboard, video, and mouse) functionality is decoupled from the computer serving the session through techniques of virtualization.

The central server computer system 105 may include a session manager and rules engine to allocate and manage sessions within the network. The central server computer system 105 may be made up of one or more server computers, workstations, web servers, or other suitable computing devices. The central server computer system 105 may be fully located within a single facility or distributed geographically, in which case a network may be used to integrate different components. Although the illustrated embodiment shows that a central server computer system 105 performs the allocation and management, in other examples these functions may be performed by a virtual server, resident in whole or in part on one of the client devices 120, or distributed among client devices 120. A client device 120 may be a personal computer, laptop, tablet, personal digital assistant (PDA), thin client, mobile device, cellular telephone, medical equipment or device, or any other computing device, and may have wired or wireless connections.

The rules for allocating sessions, monitoring sessions, generating trending rules, and applying trending rules may be stored locally by the central server computer system 105, or may be stored (in whole or in part) at data store 110. Data store 110 may be a single database, or may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may each be multiple data storages (of the same or different type), or may share a common data storage with other data stores. Although in some embodiments the data store 110 may be distinct from a central server computer system 105, in other embodiments it may be integrated therein to varying degrees.

In some examples, a central server computer system 105 monitors user sessions (e.g., via direct monitoring or via reports from client devices 120). To initiate a session, a user may log on to a client device 120 (e.g., with a user name and/or password, a key card, key fob, biometric sign-in, etc.), and the client device 120 may transmit this information to the central server computer system 105. The central server computer system 105 may direct a session to be started. When a user logs out, the session may be maintained (e.g., for a system specified time period, a user-specified time period, a user specific time period, or indefinitely). Subsequently, the user may log on to a client device 120 (the same, or different client device, from the previous log on), and the client device 120 may query the central server computer system 105 about the user and retrieve information about the session, and the session may then be served.

The central server computer system 105 may monitor the session, and evaluate the opening, closing, and use of applications and other programs as events and movement between client devices 120 occur. By way of example, any or all of the following actions may be monitored (e.g., for an application): create, hide, close, minimize, maximize, normalize, reorder, draw, paint, line, text, color, fill, clear, move, keyboard input, direct i/o, delete, open, execute, and/or kill. The central server computer system 105 may monitor and categorize monitored user actions according to user profile properties, session profile properties, location profile properties, and/or device profile properties.

User profile properties include individual users and/or types of users. Session profile properties include types of sessions and/or applications opened, closed, and/or used during the session. Device profile properties include client devices and/or types of client devices. Location profile properties include specific locations, types of locations, and/or transitions between certain locations. The central server computer system 105 may identify certain correlations between past and future actions according to user profile properties, session profile properties, device profile properties, and/or location profile properties.

Events monitored by central server computer system 105 may include workflow information and/or other information related to the user sessions. For example, information related to tasks or task status of other users, data input to the system, availability of products, and/or other information may be evaluated by the central server computer system 105. For example, when a user logs in to a client device 120 where the user may typically perform one of several tasks, the availability of information related to one of the tasks may indicate that the user session should be adapted to evaluate the information or perform the task related to the available information.

Future events may be anticipated or predicted based on an association between changes in user interaction state of users relative to the system, other information, and various trending actions that are correlated with the user interaction state changes and/or system information. A user interaction state is defined by a set of properties that indicate how and where the user is interacting with the virtual computing environment. That is, the user interaction state for a particular user is defined by the user profile properties, session profile properties, device profile properties, and/or location profile properties associated with the particular user. System information includes information related to actions that the user may perform in a given workflow.

Changes in user interaction state and/or updates to system information may be associated with trending actions that modify a session to adapt the session to the anticipated or predicted use of the session based on the change in user interaction state. Rules may be generated based on these associations. For example, the rules may specify that when particular types of users do certain things (e.g., moving between locations, moving between types of computers, using certain applications or programs, etc.), or particular types of system information have been updated (e.g., product or data availability, etc.), follow-on actions shall be initiated. The rules may include triggering events that indicate a change in user interaction state and/or system information updates, and resultant or trending actions (e.g., create, hide, close, minimize, maximize, normalize, reorder, draw, paint, line, text, color, fill, clear, move, keyboard input, direct i/o, delete, open, execute, query, and/or kill). Changes to user interaction state include changes to user profile properties, session profile properties, device profile properties, and/or location profile properties. System information updates include particular information or updates to information that may be relevant based on the change in user interaction state. The central server computer system 105 may store these rules in data store 110.

The central server computer system 105 may monitor individual sessions of the virtual computing environment, and detect changes to user interaction states. A change in user interaction state identified as a triggering event associated with a trending rule causes the system to apply the trending rule to a user session. The central server computer system 105 may call up the resultant or trending action based on the trending rule, and either modify the session or transmit modification information accordingly. Using this trending information, workflow can be anticipated and sessions can be adapted proactively.

The components of the system 100 may be directly connected, or may be connected via a network 115 which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

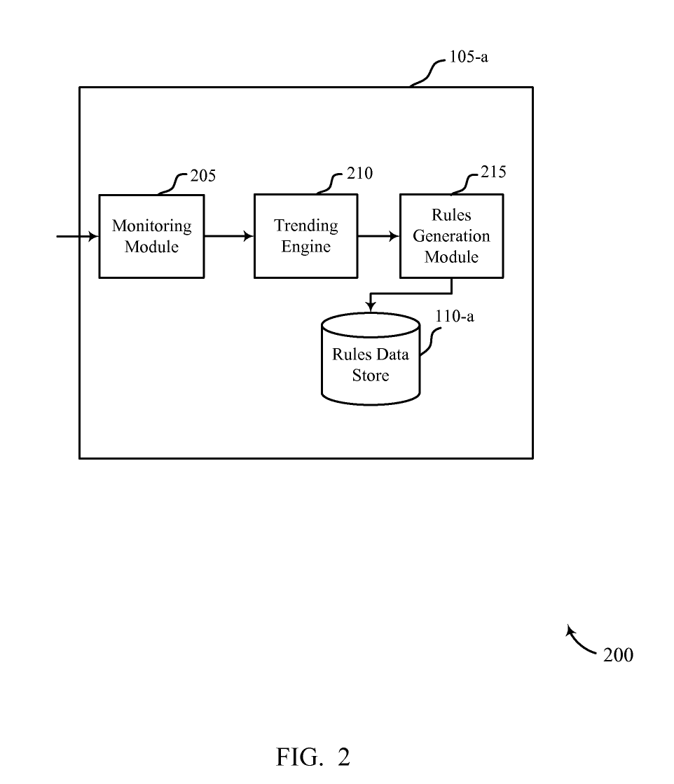

FIG. 2 is a block diagram 200 illustrating an example of central server computer system 105-a. This central server computer system 105-a, may be the central server computer system 105 described with reference to FIG. 1. The central server computer system 105-a may receive a query from client devices in a network (e.g., initiated when a user logs in), and allocate and manage sessions based on the query.

In the example illustrated in FIG. 2, the central server computer system 105-a includes a monitoring module 205, trending engine 210, rules generation module 215, and rules data store 110-a. In other examples, a central server computer system 105 may have any subset of this functionality.

Assume that a user logs on at a client device 120 (e.g., with a user name, password, key card, key fob, and/or biometric sign-in, etc.), and that the client device 120 sends a query to the central server computer system 105-a. The central server computer system 105-a may perform authentication procedures to authenticate the user logging on, and initiate a session for the user or activate KVM functionality for a currently active session. That is, the central server computer system 105-a serves the session to the client device 120 such that the user interacts with the session through the KVM functionality of the client device 120.

The monitoring module 205 may monitor workflow from one or more user sessions (e.g., via direct monitoring or via reports from client devices 120). The monitoring module 205 may monitor some or all user sessions of the virtual computing environment over a period of time. By way of example, any or all of the following actions with respect to an application, process, folder, file, peripheral device, or user interface of a session may be monitored: create, hide, close, minimize, maximize, normalize, reorder, draw, paint, line, text, color, fill, clear, move, keyboard input, direct i/o, delete, open, execute, query, and/or kill. The monitoring module 205 may associate monitored actions with a component to which the action is directed (e.g., an application or process of the session). The monitoring module 205 may monitor individual users, types of users, sessions, types of sessions, applications, types of applications, computers, types of computers, locations, types of locations, and transitions between certain locations.

Trending engine 210 may receive data from the monitoring, and identify certain correlations between past and future actions. Trending engine 210 may search for correlations between user interaction state changes and associated user workflow actions. That is, trending engine 210 identifies changes in user interaction state that tend to be associated with a subsequent user action. For example, certain users or types of users may consistently use various types of client devices according to a workflow. Movement between specific client devices or to particular client devices may indicate a particular use or part of the workflow. For example, trending engine 210 may determine that when a certain type of user logs off a first client device and subsequently logs on to a second client device, the user is likely to open and use a particular application in a particular manner. Trending engine 210 may anticipate or predict one or more resultant or trending actions based on an association between changes in user interaction states and the predicted or anticipated actions in the workflow.

Trending engine 210 may also receive other system information or workflow information. Workflow information may be user data or other information that is related to user workflow. For example, workflow information may be information related to various tasks in a workflow such as product availability or location, completion or status of workflow tasks by other users, information input by other users, and the like. Workflow information may be stored on central server computer system 105-a or may be received from a source external to central server computer system 105-a.

The trending engine 210 may apply time weighting to information received from monitoring module 205 and/or workflow information. That is, the trending engine 210 may weight user actions in recent sessions more heavily than user actions in earlier or older sessions. The trending engine 210 may also weight system information received more recently and/or that has been updated since a predetermined time (e.g., when the user last interacted with the information, etc.) more heavily than older information or older user session activity. Time weighting of information may provide a more accurate prediction of desired trending actions and provides the user with the most relevant information at stages of the workflow. Additionally, when a user or certain types of users change workflow, time weighting of monitored sessions may allow the system to adapt more quickly to the modified workflow.

Rules generation module 215 may generate rules based on these associations. For example, the rules may associate user interaction state changes and/or information updates with follow-on actions. For example, the rules may specify that when particular types of users do certain things (e.g., moving between locations, moving between types of computers, using certain applications or programs, etc.) at certain times of day or week, follow-on actions shall be initiated. The rules may also specify that when particular types of information are available, an action relevant to that information is initiated. The rules may include triggering events that indicate a change in user interaction state and/or an update to workflow information, and trending or resultant actions associated with the triggering event. That is, a triggering event includes one or more actions by a user that indicate that the user has changed how or where the user is interacting with the system and/or one or more updates to information relevant to the users workflow. Triggering events may be defined by changes in user profile properties, session profile properties, device profile properties, and/or location profile properties. For example, a triggering event for a rule generated by rules generation module 215 may be defined by a certain type of user logging off a first client device 120 and subsequently logging on to a second client device 120. The rule may associate the triggering event with a trending action, for example that a first application running in an active user session for the user should be closed and a second application should be launched within the session. Rules generation module 215 may store these rules in data store 110-a.

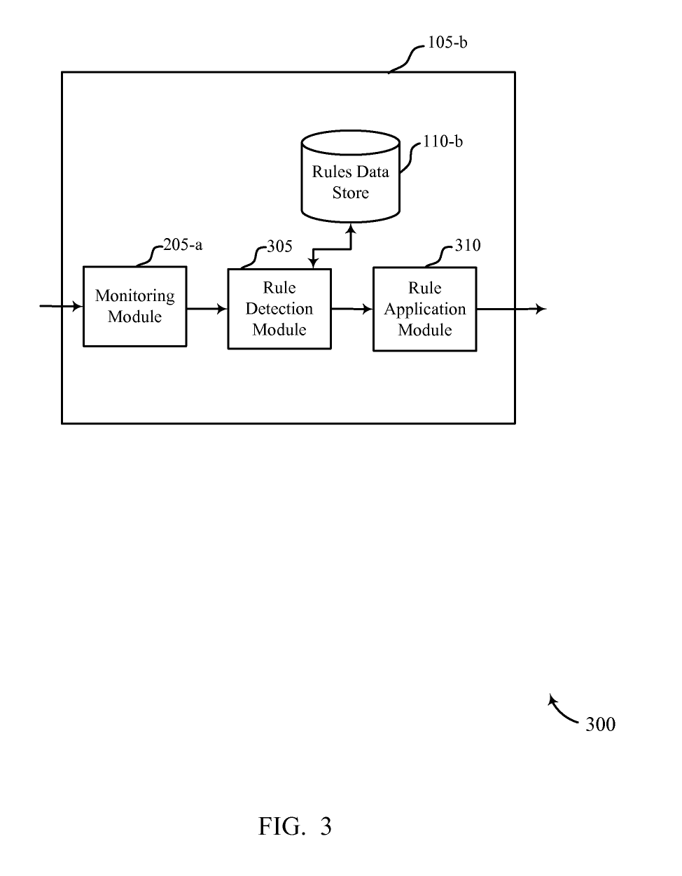

FIG. 3 is a block diagram 300 illustrating an example of central server computer system 105-b. This central server computer system 105-b, may be the central server computer system 105 described with reference to FIG. 1. The central server computer system 105-b may receive a query from client devices in a network (e.g., initiated when a user logs in), and allocate and manage sessions based on the query.

In the example illustrated in FIG. 3, the central server computer system 105-b includes a monitoring module 205-a, rule detection module 305, rule application module 310, and rules data store 110-b. Each of these components may be in communication, directly or indirectly. The monitoring module 205-a may be an example of the monitoring module 205 described above with respect to FIG. 2. Additionally, the rules data store 110-b may be an example of the data store 110 described above with respect to FIG. 1 or FIG. 2. In other examples, a central server computer system 105 may have any subset of this functionality.

As described above, monitoring module 205 monitors workflow from one or more user sessions of the virtual computing environment. The monitoring module 205 provides information related to the user interaction state of users of the system to rule detection module 220.

Rule detection module 305 receives the information related to user interaction state changes of users of the system from monitoring module 205 and/or workflow information, and detects triggering events in the information received from monitoring module 205 and workflow information. Rule detection module 305 detects when a triggering event occurs (e.g., a certain type of user using application A in region Y on machine type 2 moves to region Z and logs on to machine type 1). Rule detection module 305 may access the resultant action from rules data store 110-a, and notify rule application module 310 of the triggering event and resultant or trending action. Rule detection module 305 may access trending actions for trending rules according to a rule priority. That is, if multiple triggering events occur at the same time (e.g., as a result of change in user interaction state), rule detection module may select the trending action according to rule priority. Rule priority may be defined according to time-based criteria, task status criteria, task importance criteria, and/or other rule priority criteria.

Rule application module 310 may either modify the session or transmit modification information accordingly. For example, rule application module 310 may transmit trending action information to the session and/or an application within the session, causing the session state to be updated by the trending action information. Trending action information may include one or more of the following actions: create, hide, close, minimize, maximize, normalize, reorder, draw, paint, line, text, color, fill, clear, move, keyboard input, direct i/o, delete, open, execute, query, and/or kill. This may be done in an automated fashion, anticipating user action in a proactive manner, which may reduce wait times for applications and/or information to be loaded within the session and/or the number of user actions (e.g., “clicks,” etc.) necessary for the user during particular stages of the workflow.

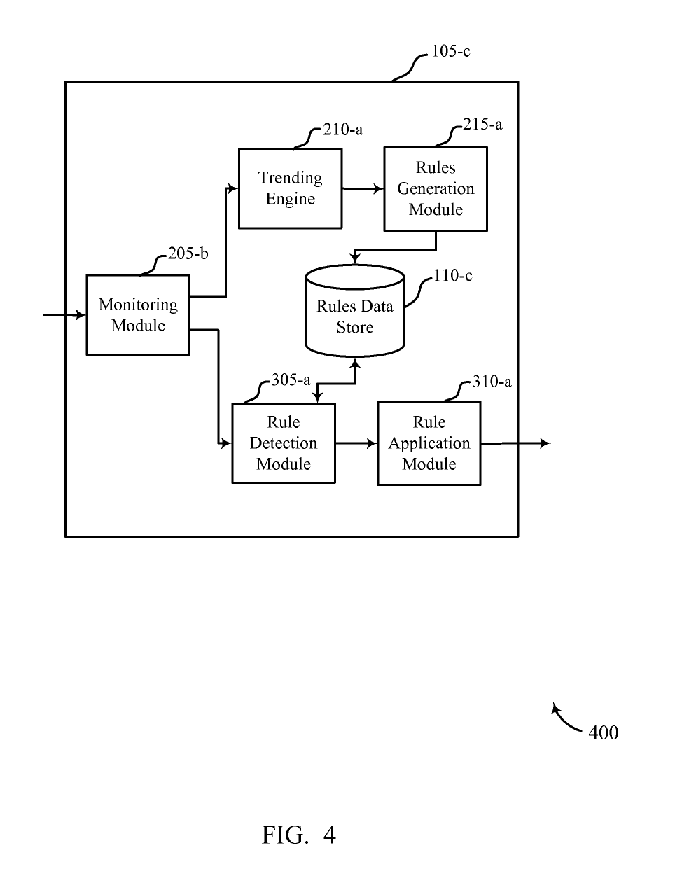

FIG. 4 is a block diagram 400 illustrating components of a central server computer system 105-c. This central server computer system 105-c may be the central server computer system 105 described with reference to FIG. 1. In the example illustrated in FIG. 4, the central server computer system 105-c includes a monitoring module 205-b, trending engine 210-a, rules generation module 215-a, rule detection module 305-a, rule application module 310-a, and rules data store 110-c. Each of these components may be in communication, directly or indirectly. The monitoring module 205-b may be an example of the monitoring module 205 described above with respect to FIG. 2 or FIG. 3. The trending engine 210-a and the rules generation module 215-a may be examples of the trending engine 210 and the rules generation module 215 described above with respect to FIG. 2. The rule detection module 305-a and the rule application module 310-a may be examples of the rule detection module 305 and the rule application module 310 described above with respect to FIG. 3. The rules data store 110-c may be an example of the data store 110 described above with respect to FIG. 1, FIG. 2, or FIG. 3. In the example, these modules monitor user sessions, recognize trends between various user actions, and proactively adapt user sessions as described above in reference to FIGS. 2 and 3. In other examples, a central server computer system 105 may have any subset of this functionality.

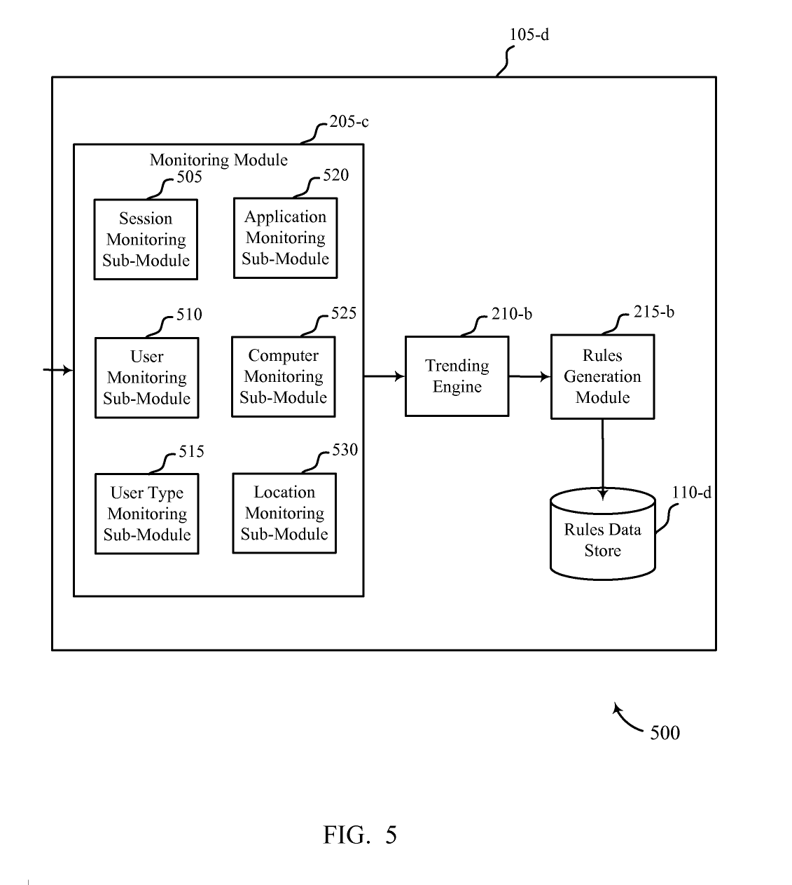

FIG. 5 is a block diagram 500 illustrating components of a central server computer system 105-d. This central server computer system 105-d may be the central server computer system 105 described with reference to FIG. 1. The central server computer system 105-d may include a monitoring module 205-c, trending engine 210-b, rules generation module 215-b, and rules data store 110-d. Each of these components may be in communication, directly or indirectly. These components may be respective examples of the monitoring module 205, trending engine 210, rules generation module 215, and rules data store 110 described above with respect to FIG. 2, FIG. 3, or FIG. 4. The monitoring module 205-a of the present example includes session monitoring sub-module 505, user monitoring sub-module 510, user type monitoring sub-module 515, application monitoring sub-module 520, client device monitoring sub-module 525, and location monitoring sub-module 530. In other examples, a central server computer system may have any subset of this functionality. The central server computer system may receive a query from computers in a network (e.g., initiated when a user logs in), and allocate and manage sessions based on the query.

The monitoring module 205-c may monitor user sessions. Session monitoring sub-module 505 may monitor sessions and session types; user monitoring sub-module 510 may monitor specific users; user type monitoring sub-module 515 may monitor types of users; application monitoring sub-module 520 may monitor use of applications and other programs, computer monitoring sub-module 525 may monitor computers and computer types; and location monitoring sub-module 530 may monitor locations, types of locations, and movement between locations. Trending engine 210-b may receive data from the monitoring, and identify certain correlations between past events and future user actions. Trending engine 210-b may search for correlations between user interaction state changes and trending actions. Trending engine may search for correlations in user interaction state changes based on types of users, their use of different computers and applications, and how movement between specific computers or to a particular computer results in consistent workflow changes.

Rules generation module 215-b may generate rules based on these associations. For example, the rules may specify that when particular types of users perform an action X, follow-on action Y shall be initiated. The rule may include triggering events (defined by user type, application/computer type, location, location transition, or session type), and resultant actions. Rules generation module 215-b may store these rules in data store 110-d.

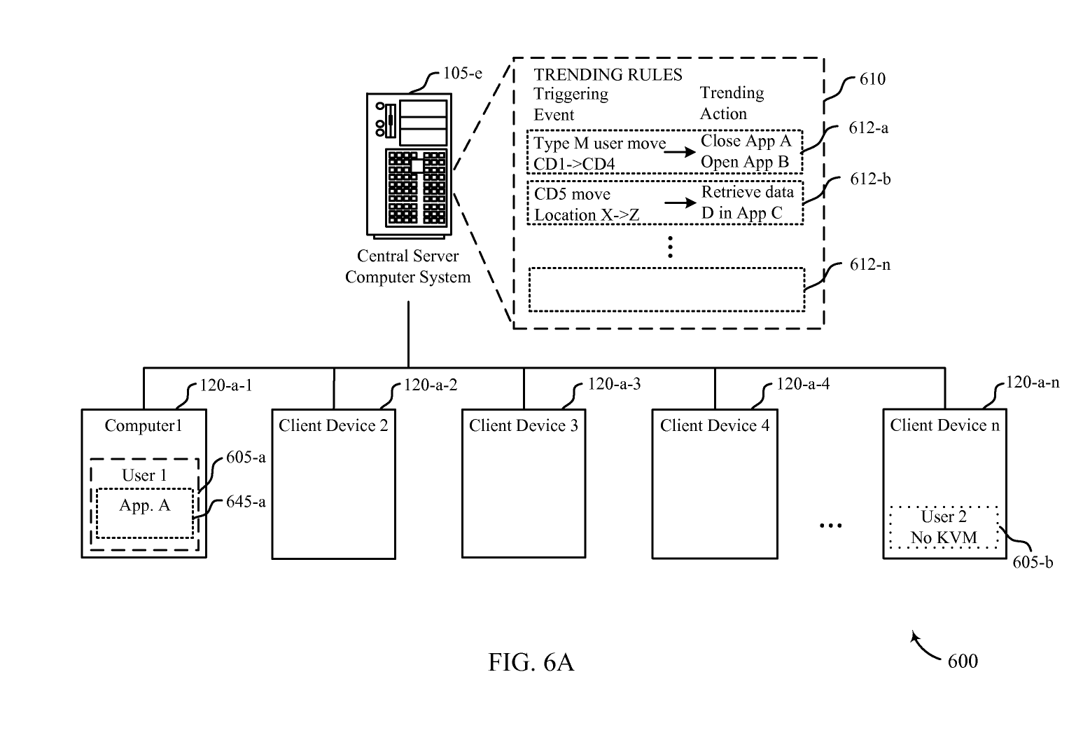

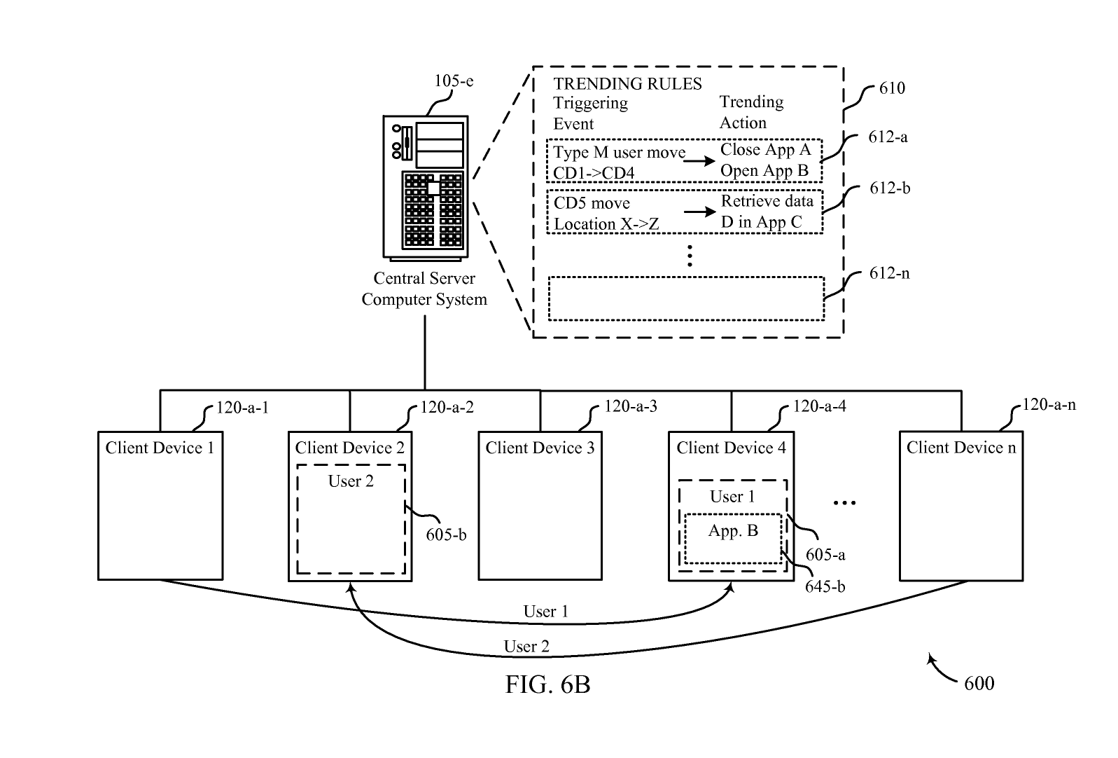

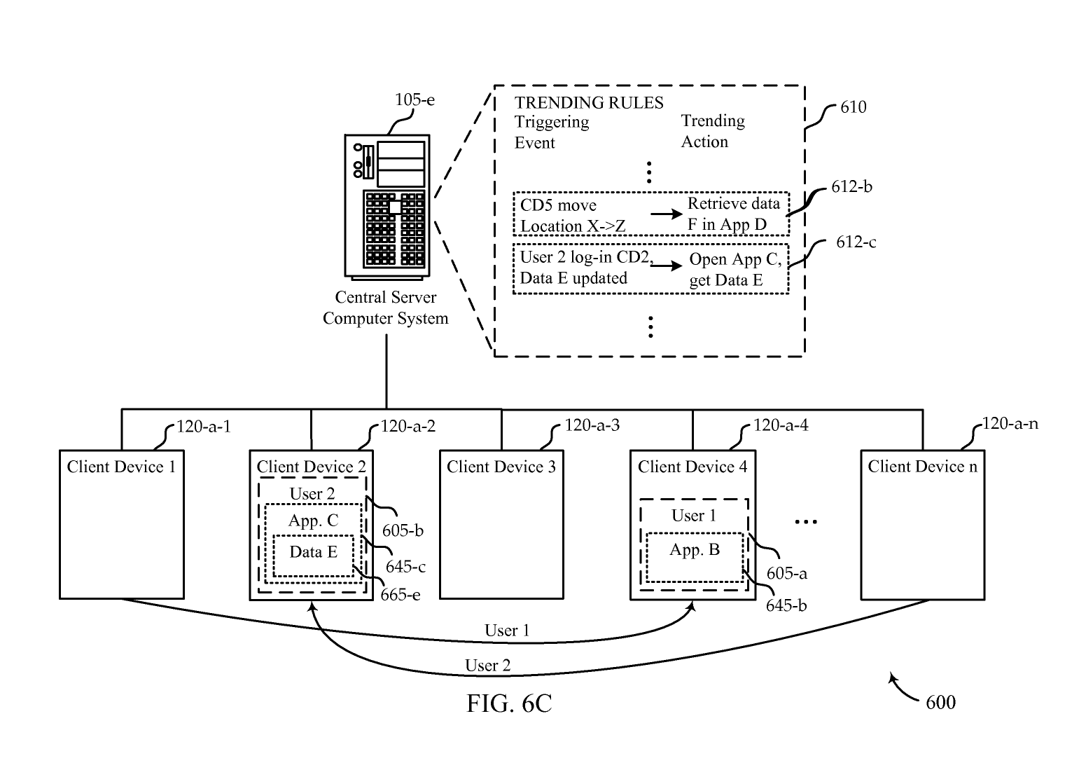

Turning next to FIGS. 6A, 6B, and 6C, these diagrams illustrate an example of the system 100 of FIG. 1. System 600 of FIGS. 6A, 6B, and 6C includes a central server computer system 105-e and client devices 120-a. The central server computer system 105-e may be the central server computer system 105 of FIG. 1, 2, 3, or 4. The client devices 120 may be the client devices 120 of FIG. 1. Each of these components may be in communication with each other, directly or indirectly.

Referring first to FIG. 6A of the system 600 at an initial period of time, user 1 logs onto client device 120-a-1. The client device 120-a-1 may query the central server computer system 105-b about the user, and the central server computer system 105-b may authenticate the user and check to see if the user has a current session running. The central server computer system 105-b may direct a session 605-a to be started, and the session 605-a may be provided to the client device 120-a-1 that the user logged into. Client device 120-a-1 provides KVM functionality for the session 605-a such that the user 1 can interact with the session 605-a through client device 120-a-1.

In system 600, user 2 was previously logged in to client device 120-a-n, and therefore also had a session 605-b running, with KVM functionality on client device 120-a-n, but has logged out, and thus the KVM functions are deactivated. Session 605-b may be maintained on central server computer system 105-e, although it is not presently served to a client device 120.

The user 1 may interact with the session 605-a while logged in to client device 120-a-1. For example, the user may open or close applications, modify the desktop appearance, enter information to various applications, and/or retrieve information using applications and/or other components of session 605-a, among other interactions. Modifications and actions performed by user 1 in session 605-a result in a current session state for user 1. For example, user 1 may open application A 645-a within session 605-a while logged in to client device 120-a-1.

As described above, a user interaction state for user 1 in FIG. 6A may be defined by user profile properties, session profile properties, device properties, and/or location properties. For example, user profile properties of user 1 may include a user type of M. Session profile properties may include a session type, open applications, data queries, and/or other session related properties. In this example, session profile properties for session 605-a include the state of application A 645-a. Device profile properties may include a client device type of client device 120-a-1 and other properties associated with client device 120-a-1. Location profile properties may include a location associated with client device 120-a-1 such as a room location where client device 120-a-1 is connected to network 115 or a location region that is indicated by client device 120-a-1.

After interacting with session 605-a using client device 120-a-1 for a period of time, user 1 logs off of client device 120-a-1. Central server computer system 105-e may maintain session 605-a after user 1 logs off of client device 120-a-1. That is, the current session state of session 605-a may be maintained by central server computer system 105-b while user 1 is logged out of system 600 such that the session 605-a is ready to be served to the same or another client device 120 when user 1 logs back in to the system 600. Central server computer system 105-e also stores information related to the last user interaction state of user 1. In this example, the central server computer system 105-e maintains the information that user 1 has logged off of client device 120-a-1.

Referring next to FIG. 6B of the system 600 at a later period of time, user 1 moves to client device 120-a-4 and logs back on to system 600. The user 1 may move from client device 120-a-1 to client device 120-a-4 for various reasons including a change in location. For example, client device 120-a-1 may be in a first location where user 1 is performing a first task (e.g., entering and/or retrieving a first set of information), and computer 120-a-4 may be in a second location where user 1 performs a second task (e.g., entering and/or retrieving a second set of information). The client device 120-a-4 may query the central server computer system 105-e about the user, and the central server computer system 105-e may authenticate the user and check to see that the user has a current session 605-a running. The central server computer system 105-e may monitor the movement of user 1 between client devices 120-a-1 and 120-a-4 and identify a triggering event based on one or more changes in user interaction state. For example, the triggering event may be based on the type of user and the application used at client device 120-a-1.

Central server computer system 105-e stores trending rules 610 that associate triggering events with trending actions based on changes in user interaction state with system 600. Trending rules 610 may be generated by trending engine 210 and stored in a rules data store (e.g., data store 110 of FIGS. 1-5) of central server computer system 105-e, as described above. Central server computer system 105-e monitors changes in user interaction state of user 1 and identifies triggering events in trending rules 610 that correspond to changes in user interaction state.

In the example, the movement between client devices 120-a-1 and 120-a-4 for the applicable type of user is a triggering event. That is, user 1 may be associated with a particular user type (e.g., user type M, etc.), and the movement of a user of that particular user type from a client device 120-a-1 to client device 120-a-4 may be a triggering event. As indicated in FIG. 6B, a user interaction state change corresponding to the movement of a user of user type M from client device 120-a-1 to client device 120-a-4 triggers rule 612-a of trending rules 610.

The central server computer system 105-e calls up rule 612-a and identifies certain resultant or trending actions associated with the triggering event. As described above, the trending actions may modify the current state of the session 605-a. For example, certain applications that were running in session 605-a when the user was at client device 120-a-1 may be shut down or hidden, while new applications may be opened. In the example shown in FIG. 6B, the rule 612-a associated with the triggering event closes application A and opens application B. In system 600, the trending actions may be performed automatically based on detection of changes in user interaction state that correspond with triggering events.

As described above, user 2 also has a session 605-b running. In FIG. 6B, user 2 logs in at client device 120-a-2. The client device 120-a-2 may query the central server computer system 105-e about user 2, and the central server computer system 105-e may authenticate the user and check to see that the user has a current session 605-b running. The central server computer system 105-e may monitor the movement to of user 2 from client device 120-a-n to client device 120-a-2 and determine a change in user interaction state of user 2 based on the change in user profile, session profile, device profile, and/or location profile properties of user 2. The central server computer system 105-e may determine that the change in user interaction state of user 2 does not correspond with a triggering event in trending rules 610. In this instance, no triggering event has occurred, and thus central server computer system 105-e takes no resultant action for session 605-b. The central server computer system 105-e then serves session 605-b to client device 120-a-2.

FIG. 6C shows an alternative state of system 600 to FIG. 6B, again at a later period of time than FIG. 6A. In FIG. 6C, workflow information related to the workflow of user 2 was updated before user 2 logs in to client device 120-a-2. In this instance, the movement between client devices 120-a-n and 120-a-2 for user 2 is a triggering event. Because data E has been updated within a predetermined time period (e.g., since the last time user 2 logged in to client device 120-a-2, etc.) before user 2 logs in to client device 120-a-2, central server computer system 105-e detects the triggering event for rule 612-c. The trending action for rule 612-c is applied by central server computer system 105-e to session 605-b which results in application C 645-c being opened and data E 665-e being retrieved and loaded into application C 645-c.

In this example, the rule 612-c may be generated by central server computer system 105-e by identifying trends associated with user sessions and/or data or information that is relevant to the user sessions. That is, central server computer system 105-e may identify a particular stage in the workflow associated with the log in of user 2 to client device 120-a-2, and generate rule 612-c based on the relevance of updated data associated with that stage in the workflow. For example, in FIG. 6C user 2 may be a healthcare professional that has logged-in to client device 120-a-2 in a patient's room and data E 665-e may represent X-ray images associated with care for the patient. In this instance, rule 612-c is generated based on trending information and workflow information associated with the workflow of the healthcare professional (e.g., rounds, etc.). For example, the trending information may indicate the particular stage of workflow that the current log-in by the healthcare professional represents. For example, the trending information may differentiate between a log-in of the healthcare professional to the client device 120-a-2 for different purposes (e.g., medication rounds vs. other types of rounds, etc.). If the updated data E 665-e is relevant to the purpose of the log-in identified by the trending engine, the rule 612-c may be triggered. When the healthcare professional logs in to the client device, the updated workflow information including the new X-rays are automatically loaded for examination by the healthcare professional.

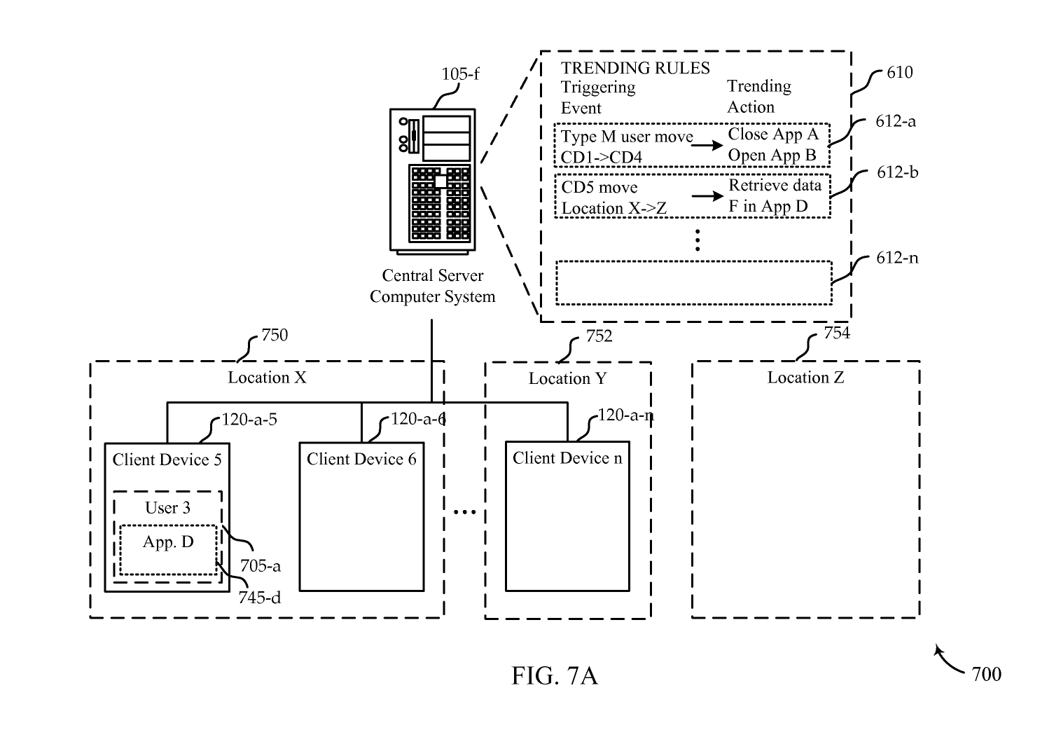

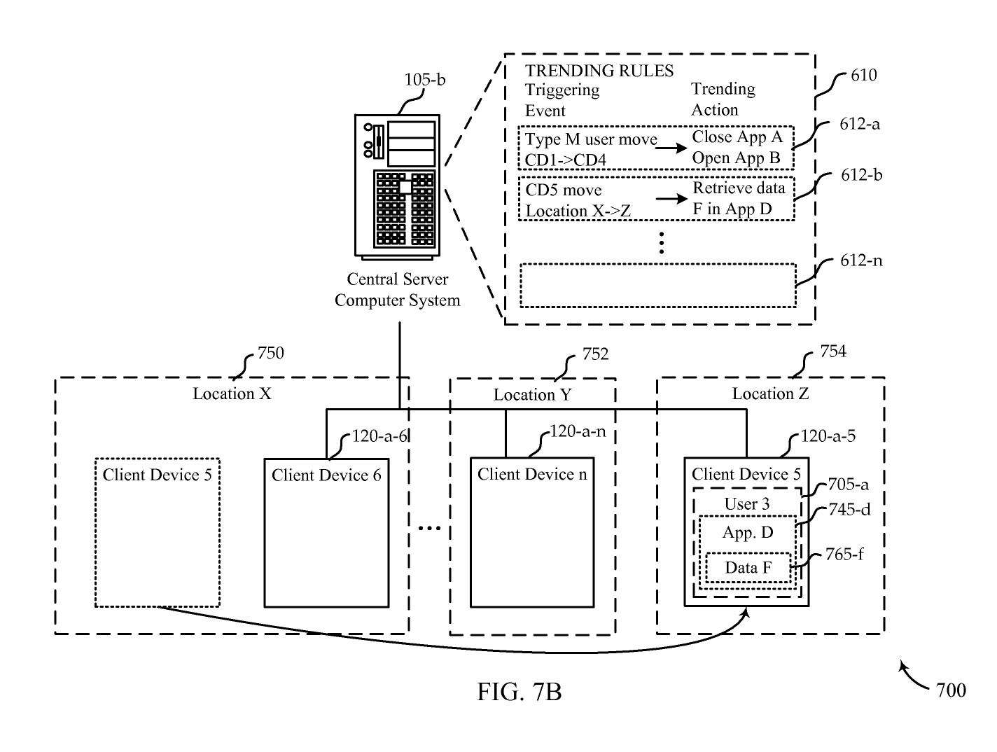

Turning next to FIGS. 7A and 7B, system 700 illustrates another example of proactive adaptation of sessions in a virtual computing environment. System 700 of FIGS. 7A and 7B includes a central server computer system 105-f and client devices 120. The central server computer system 105-f may be the central server computer system 105 of FIG. 1, 2, 3, 4, or 5. The client devices 120 may be the client devices 102 of FIG. 1 or FIGS. 6A-6C. Each of these components may be in communication with each other, directly or indirectly. Client devices 120 may be located in several location regions. In the example illustrated in FIG. 7A, client devices 120 may be located in one of location region X 750, location region Y 752, and/or location region Z 754.

Referring first to FIG. 7A of the system 700 at an initial period of time, user 3 logs onto client device 120-a-5 while client device 120-a-5 is located in location region X. The client device 120-a-5 may query the central server computer system 105-f about the user, and the central server computer system 105-f may authenticate the user and check to see if the user has a current session running. The central server computer system 105-f may direct a session 705-a to be started, and the session 705-a may be provided to the client device 120-a-5 that the user logged into. Initially, client device 120-a-5 is located in location region X 750. Client device 120-a-5 provides KVM functionality for the session 705-a such that the user 3 interacts with session 705-a through client device 120-a-5.

The user 3 may interact with the session 705-a while logged in to client device 120-a-5 in location region X 750. For example, the user may open or close applications, modify the desktop appearance, enter information to various applications, and/or retrieve information using applications and/or other components of session 705-a, among other interactions. Modifications and actions performed by user 3 in session 705-a result in a current session state of session 705-a. In the example illustrated in FIG. 7A, user 3 opens application D 745-d within session 705-a while logged in to client device 120-a-5 in location region X 750.

Referring next to FIG. 7B of the system 700 at a later period of time, user 3 moves from location region X 750 to location region Z 754 with client device 120-a-5. For example, client device 120-a-5 may be a portable device such as a tablet or smartphone, and user 3 may carry client device 120-a-5 from location X 750 (e.g., a first room within a building, etc.) to location region Z 754 (e.g., a second room of the same building, etc.). For example, a user such as a health care professional may open and interact with a particular application (e.g., medical records application and the like) in a first location (e.g., patient room, etc.). The user may then leave the first location and move to a second location (e.g., another patient room, etc.). In this instance, user 3 may or may not log out of client device 120-a-5 while moving from location region X to location region Z.

Central server computer system 105-f receives information about the movement of users and client devices 120. For example, client device 120-a-5 may track its location using a location sensing device (e.g., GPS, etc.) and relay its location to central server computer system 105-f. Based on the movement of a client device 120 from a first location to a second location, central server computer system 105-f may detect a triggering event based on the change in user interaction state. For example, when user 3 moves client device 120-a-5 from location region X 750 to location region Z 754 with application D open, rule 612-b may be triggered. The central server computer system 105-f calls up rule 612-b and identifies certain resultant or trending actions associated with the triggering event according to the rule. As described above, the trending actions of rule 612-b may modify the current state of the session 705-c. For example, the trending actions may modify the session 705-c such that it is set up for use in location region Z 754. In the example shown in FIG. 7B, the rule 612-b associated with the triggering event retrieves data set F 765-f for use within application D 745-d. That is, the trending action of rule 612-b may be a database query that retrieves data set F 765-f within application D 745-d. Data set F 765-f may be, for example, records associated with location region Z 754 (e.g., medical records of a patient in a particular room, etc.). These actions may be performed automatically based on the monitored changes in user interaction state of user 3.

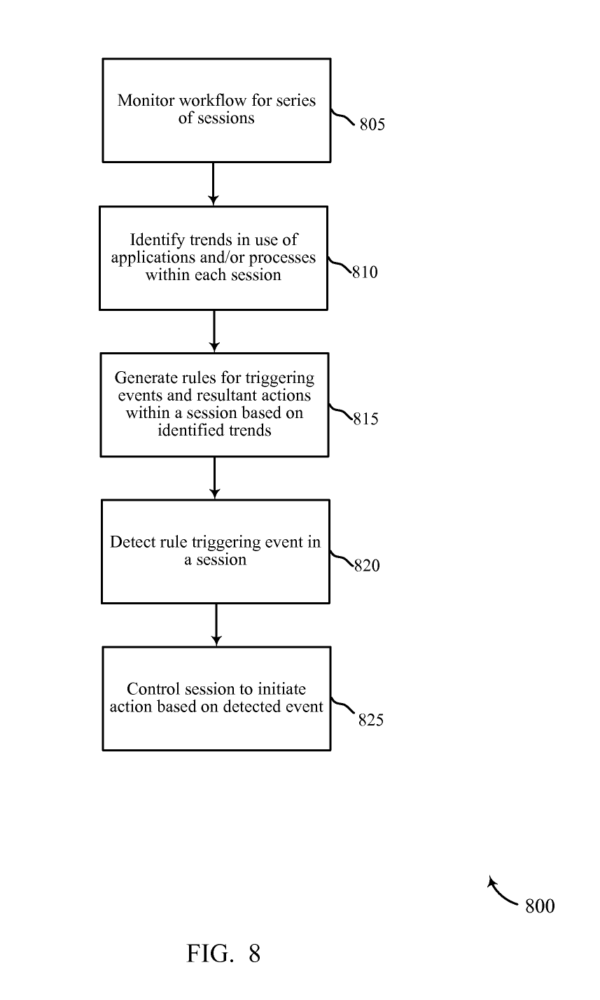

Referring next to FIG. 8, a flow chart is shown illustrating a method 800 for roaming and session management in a virtual desktop environment. This method 800 may, for example, be performed in whole or in part by systems 100, 600, and/or 700 of FIGS. 1, 6A, 6B, 7A, and/or 7B, or the central server computer system 105 of FIGS. 1-7B.

At block 805 of method 800, workflow for series of sessions is monitored. At block 810, trends in use of applications and/or processes within each session are identified. That is, correlations between changes in user interaction state of users to the system and subsequent user actions are identified. At block 815, rules for triggering events and resultant actions within a session are generated, based on identified trends. At block 820, a rule triggering event in a session is detected. At block 825, the session is controlled to initiate the action based on the detected event.

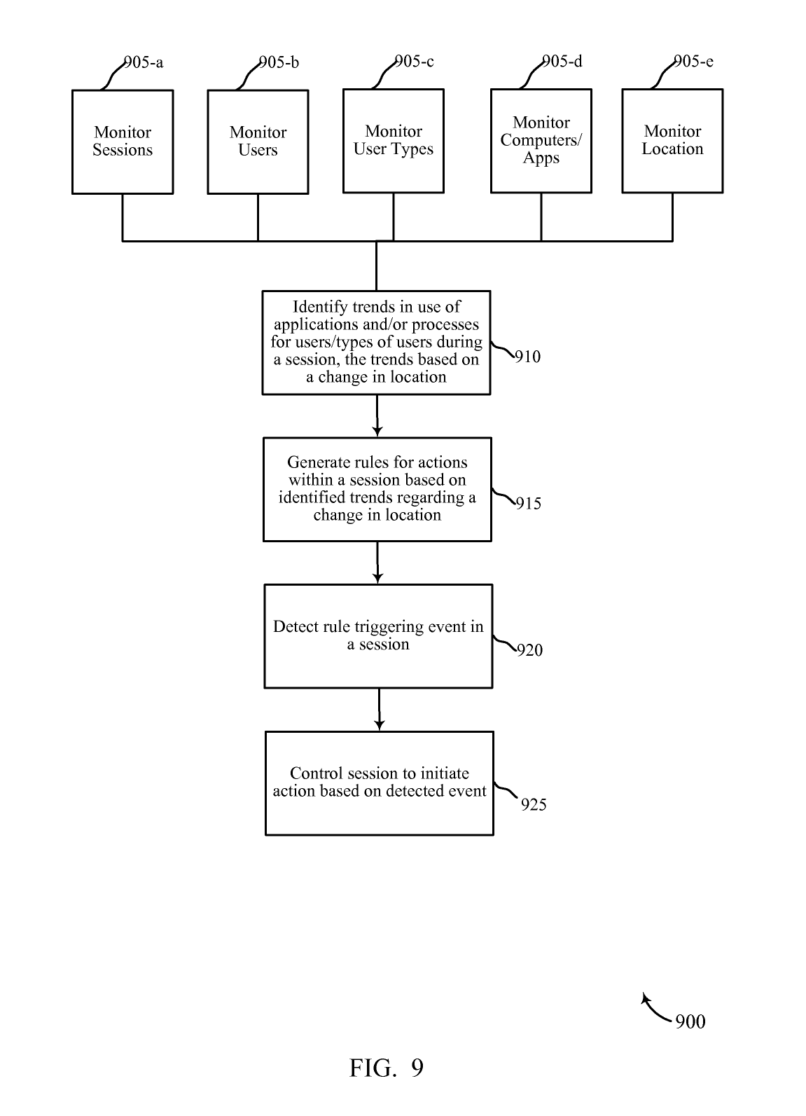

Referring next to FIG. 9, a flow chart is shown illustrating an alternative method 900 for roaming and session management in a virtual desktop environment. This method 900 may, for example, be performed in whole or in part by systems 100, 600, and/or 700 of FIGS. 1, 6A, 6B, 7A, and/or 7B, or the central server computer system 105 of FIGS. 1-7B.

At blocks 905-a through 905-e, sessions, users, user types, machines, applications, and locations are monitored. At block 910, trends in use of applications and/or processes are identified for users/types of users during a session, the trends based on a change in location. At block 915, rules for actions are generated within a session based on identified trends regarding a change in location. At block 920, a rule triggering event in a session is detected. At block 925, a session is controlled to initiate action based on the detected event.

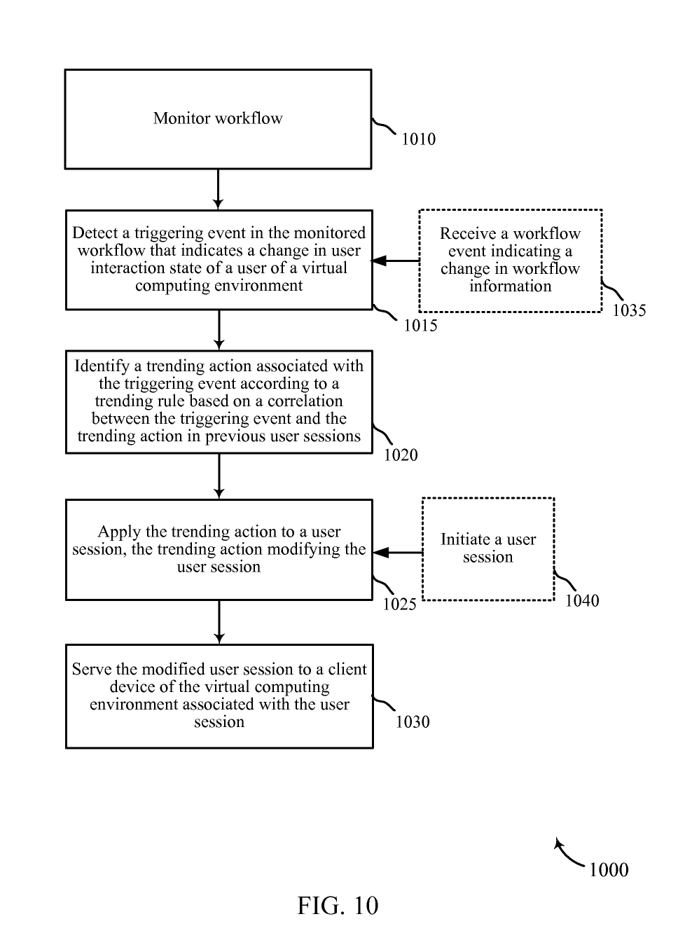

Referring next to FIG. 10, a flow chart is shown illustrating a method 1000 for roaming and session management in a virtual desktop environment. This method 1100 may, for example, be performed in whole or in part by systems 100, 600, and/or 700 of FIGS. 1, 6A, 6B, 7A, and/or 7B, or the server 105 of FIG. 1, 2, 3, or 4.

At block 1010 of method 1000, workflow is monitored for one or more user sessions of the virtual computing environment. At block 1015, a triggering event is detected that indicates a change in user interaction state of a user of a virtual computing environment. The triggering event may indicate a change in user interaction state related to one or more user profile properties, session profile properties, device properties, and/or location properties. In certain embodiments, a workflow event is received at block 1035 that indicates a change in workflow information and detection of the triggering event may also be based on the received workflow event.

At block 1020 of method 1000, a trending action is identified that is associated with the triggering event according to a trending rule. The trending rule is based on a correlation between the triggering event and the trending action is previous user sessions. At block 1025, the trending action is applied to a user session and modifies the user session. In embodiments, the user session is initiated at block 1040 in method 1000, The user session may be initiated at block 1040 in response to a log-in of the user to a client device of the virtual computing environment. For example, the user session may be initiated if no user session is currently active for the user when the user logs in to the system.

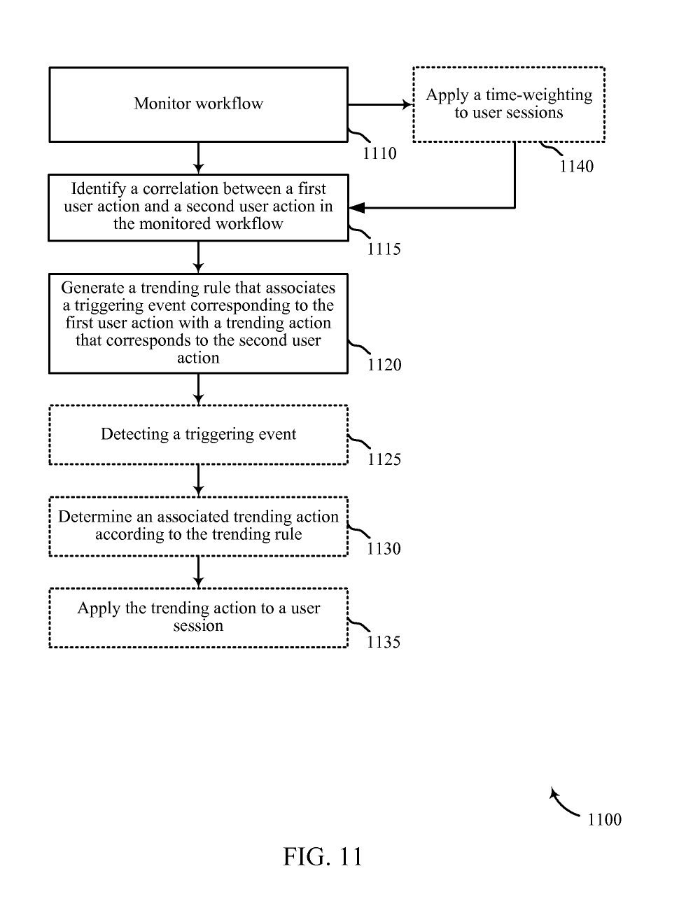

Referring next to FIG. 11, a flow chart is shown illustrating a method 1100 for roaming and session management in a virtual desktop environment. This method 1100 may, for example, be performed in whole or in part by systems 100, 600, and/or 700 of FIGS. 1, 6A, 6B, 7A, and/or 7B, or the server 105 of FIG. 1, 2, 3, or 4.

At block 1110 of method 1100, workflow is monitored for one or more user sessions of the virtual computing environment. At block 1115, a correlation is identified between a first user action and a second user action in the monitored workflow. For example, the correlation may indicate that specific users or users of a particular type have a high likelihood of performing the second user action subsequently to the first user action. Identifying the correlation may take into account time-weighting of actions in the monitored workflow at block 1140. At block 1120, a trending rule is generated that associates a triggering event corresponding to the first user action with a trending action that corresponds to the second user action.

The method may further include proactively adapting a user session according to blocks 1125, 1130, and 1135 of the method 1100. For example, the triggering event may be detected at block 1125. The associated trending action is determined at block 1130 according to the trending rule. At block 1135, the trending action is applied to the user session. The user session is modified by the trending action to be proactively adapted for the predicted workflow of the user.

The functionality of the central server computer system 105 of FIG. 1, 2, 3, 6A, 6B, 6C, 7A or 7B; the monitoring module of 205 of FIG. 2, 3, 4, or 5; the trending engine 210 of FIG. 2, 4, or 5; the rules generation module of FIG. 2, 4, or 5; the rules detection module 305 of FIG. 3 or 5; the rule application module 310 of FIG. 3 or 5; and the client devices 120 of FIG. 1, 6A, 6B, 6C, 7A or 7B, may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

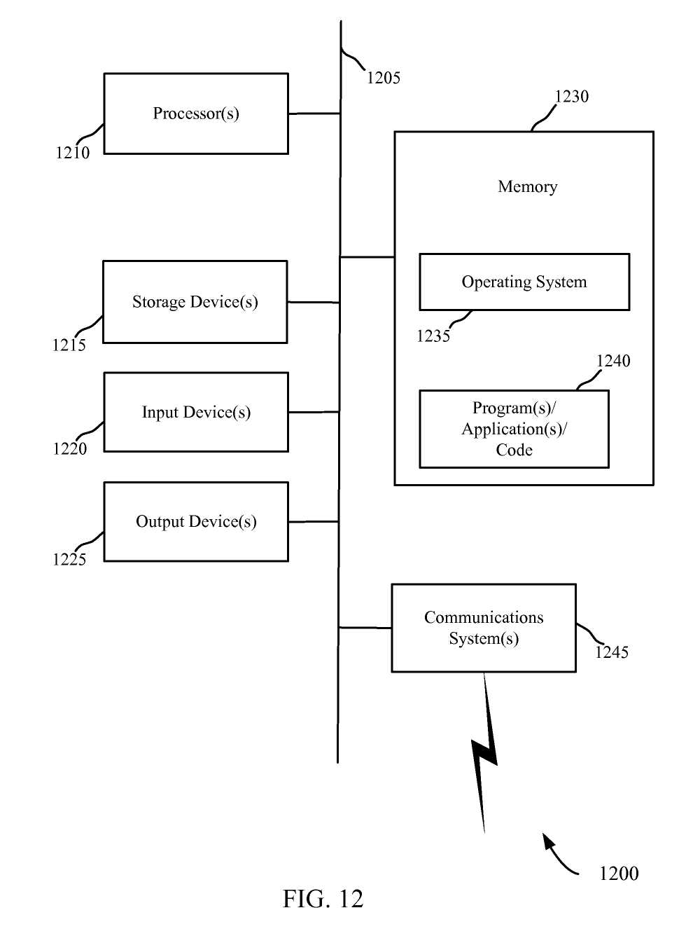

A device structure 1200 that may be used for one or more components of central server computer system 105 of FIG. 1, 2, 3, 6A, 6B, 6C, 7A or 7B, or the client device 120 of FIG. 1, 2, 6A, 6B, 6C, 7A or 7B, or for other computing devices described herein, is illustrated with the schematic diagram of FIG. 12. This drawing broadly illustrates how individual system elements of each of the aforementioned devices may be implemented, whether in a separated or more integrated manner. Thus, any or all of the various components of one of the aforementioned devices may be combined in a single unit or separately maintained and can further be distributed in multiple groupings or physical units or across multiple locations. The example structure shown is made up of hardware elements that are electrically coupled via bus 1205, including processor(s) 1210 (which may further comprise a DSP or special-purpose processor), storage device(s) 1215, input device(s) 1220, and output device(s) 1225. The storage device(s) 1215 may be a machine-readable storage media reader connected to any machine-readable storage medium, the combination comprehensively representing remote, local, fixed, or removable storage devices or storage media for temporarily or more permanently containing computer-readable information. The communications system(s) interface 1245 may interface to a wired, wireless, or other type of interfacing connection that permits data to be exchanged with other devices. The communications system(s) interface 1245 may permit data to be exchanged with a network.

The structure 1200 may also include additional software elements, shown as being currently located within working memory 1230, including an operating system 1235 and other code 1240, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for session management in a virtual computing environment, the method comprising:
monitoring workflow for a series of user sessions;
detecting a triggering event in the monitored workflow, the triggering event indicating a change in user interaction state of a user of the virtual computing environment;
identifying a trending action associated with the triggering event according to a trending rule, wherein the trending rule is based on a correlation between the triggering event and the trending action in previous user sessions;
applying the trending action to a user session, the trending action modifying the user session; and
serving the modified user session to a computer of the virtual computing environment associated with the user session.

2. The method of claim 1, further comprising:
identifying a correlation between the triggering event and the trending action for users of a first user type in the monitored workflow; and
generating the trending rule associating the trending action with the triggering event according to the first user type.

3. The method of claim 1, wherein the detecting the triggering event comprises:
determining that a user has logged in to a client device of the virtual computing environment;
determining a location transition of the user based on the client device and information related to a previous log-in of the user to the virtual computing environment; and
identifying a triggering event associated with the location transition.

4. The method of claim 1, further comprising:
determining that a user has logged in to a client device of the virtual computing environment;
determining a user type associated with the user based on a user log-in information received; and
detecting the triggering event based at least in part on the user type.

5. The method of claim 1, further comprising:
determining that a user has logged in to a client device of the virtual computing environment; and
initiating the user session in response to the user log-in.

6. The method of claim 1, further comprising:
receiving a workflow event indicating a change in workflow information; and
detecting the triggering event in the monitored workflow based at least in part on the workflow event.

7. A computer system for managing sessions in a virtual computing environment, the computer system comprising:
a monitoring module configured to monitor workflow for a series of user sessions;
a rules detection module configured to detect a triggering event in the monitored workflow that indicates a change in user interaction state of a user of the virtual computing environment;
a rules data store configured to store a trending rule, the trending rule associating a trending action with the triggering event based on a correlation between the triggering event and the trending action in previous user sessions; and
a rule application module configured to apply the trending action to a user session, the trending action modifying the user session before the user session is served to a client device of the virtual computing environment.

8. The computer system of claim 7, further comprising:
a monitoring module configured to monitor workflow for a series of user sessions;
a trending engine configured to identify the correlation between the triggering event and the trending action for users of a first user type in the monitored workflow; and
a rules generator configured to generate the trending rule associating the trending action with the triggering event according to the first user type.

9. The computer system of claim 7, wherein the rules detection module is configured to detect the triggering event according to a location transition, the location transition determined based on a user log-in to a client device of the virtual computing environment and information related to a previous log-in of the user to the virtual computing environment.

10. The computer system of claim 7, wherein the rules detection module is configured to:
determine that a user has logged in to a client device of the virtual computing environment;
determine a user type associated with the user based on user log-in information, and
identifies the triggering event based at least in part on the user type.

11. The computer system of claim 7, wherein the computer system is configured to:
determine that a user has logged in to a client device of the virtual computing environment; and
initiate the user session in response to the user log-in.

12. The computer system of claim 7, wherein:
the monitoring module is configured to receive a workflow event indicating a change in workflow information; and
the rules detection module is configured to detect the triggering event in the monitored workflow at least in part on the workflow event.

13. A method for managing user sessions in a virtual computing environment, the method comprising:
monitoring workflow of one or more user sessions;
identifying a correlation between a first user action and a second user action of the monitored workflow; and
generating a trending rule that associates a triggering event corresponding to the first user action with a trending action that corresponds to the second user action.

14. The method of claim 13, further comprising:
detecting the triggering event;
determining an associated trending action according to the trending rule; and
applying the trending action to a user session, the trending action modifying the user session.

15. The method of claim 13, wherein identifying the correlation between the first user action and the second user action is based at least in part on a user type.

16. The method of claim 13, wherein identifying the correlation between the first user action and the second user action is based at least in part on a session type.

17. The method of claim 13, wherein monitoring workflow comprises applying a time weighting to the one or more monitored user sessions.

18. A computer system for managing user sessions in a virtual computing environment, the computer system comprising:
a monitoring module configured to monitor workflow in one or more user sessions;
a trending engine configured to identify a correlation between a first user action and a second user action of the monitored workflow; and
a rules generation module configured to generate a trending rule that associates a triggering event corresponding to the first user action with a trending action that corresponds to the second user action.

19. The computer system of claim 18, further comprising:
a rule detection module configured to detect the triggering event; and
a rule application module configured to apply the trending action associated with the triggering event according to the trending rule to the user session, wherein application of the trending action to the user session modifies the user session.

20. The computer system of claim 18, wherein the trending engine is configured to identify the correlation between the first user action and the second user action at least in part on a user type.

21. The computer system of claim 18, wherein the trending engine is configured to identify the correlation between the first user action and the second user action at least in part on a location transition.

22. The computer system of claim 18, wherein the monitoring module applies a time weighting to the one or more monitored user sessions.
